(19) United States
(12) Patent Application Publication
(10) Pub. No.: US 2026/0104862 A1
(43) Pub. Date: Apr. 16, 2026

(54) CONTEXTUAL AI CODE GENERATOR CONSIDERING FUNCTION CORRELATION AND CODE PATTERN

(71) Applicant: Dell Products L.P., Round Rock, TX (US)

(72) Inventors: Min Gong, Shanghai (CN); Xiang Zhang, Shanghai (CN); Anthony Fernandez, Austin, TX (US)

(21) Appl. No.: 18/914,906

(22) Filed: Oct. 14, 2024

(51) Int. Cl. G06F 8/35

(52) U.S. Cl. CPC G06F 8/35

(57) ABSTRACT

A method for generating code candidates includes receiving user input generated by a user of the client. The method includes obtaining user input embeddings. The method includes querying a function profile store to obtain a list of relevant functions. The method includes querying a function correlation store to obtain a list of related functions and a corresponding code segment reference for each related function in the list of related functions. The method includes selecting, based on a correlation score of each related function from the list of related functions and a threshold, a highest ranked code segment reference to obtain a list of correlated functions. The method includes removing duplicate functions between the list of relevant functions and the list of correlated functions to obtain a list of target functions. The method includes using at least the list of target functions to generate a plurality of code candidates.

### BACKGROUND

Models (e.g., artificial intelligence (AI) models, machine learning models, etc.) are able to generate code based on user input requirements. However, existing approaches lack contextual awareness, resulting in the generated code being too generalized.

### SUMMARY

In general, described herein relate to a method for generating code candidates. The method includes receiving, from a client, user input generated by a user of the client. The method also includes obtaining, based on the user input, user input embeddings. Further, the method includes querying, using the user input embeddings, a function profile store to obtain a list of relevant functions. In addition, the method includes querying, using the list of relevant functions, a function correlation store to obtain a list of related functions and a corresponding code segment reference for each related function in the list of related functions. Moreover, the method includes selecting, based on a correlation score of each related function from the list of related functions and a threshold, a highest ranked code segment reference to obtain a list of correlated functions. Also, the method includes removing duplicate functions between the list of relevant functions and the list of correlated functions to obtain a list of target functions. Further, the method includes using at least the list of target functions to generate a plurality of code candidates.

In general, embodiments described herein relate to a non-transitory computer readable medium including computer readable program code, which when executed by a computer processor, enable the computer processor to perform a method for generating code candidates. The method includes receiving user input generated by a user. The method also includes obtaining, based on the user input, user input embeddings. Further, the method includes querying, using the user input embeddings, a function profile store to obtain a list of relevant functions. Moreover, querying, using the list of relevant functions, a function correlation store to obtain a list of related functions and a corresponding code segment reference for each related function in the list of related functions. Also, the method includes selecting, based on a correlation score for each related function from the list of related functions and a threshold, a highest ranked code segment reference to obtain a list of correlated functions. Further, the method includes removing duplicate functions between the list of relevant functions and the list of correlated functions to obtain a list of target functions. The method also includes using at least the list of target functions to generate a plurality of code candidates.

In general, embodiments described herein relate to a contextual code generator to generate a plurality of code candidates. The method includes receiving, from a client, user input generated by a user of the client. The method also includes obtaining, based on the user input, user input embeddings. Further, the method includes querying, using the user input embeddings, a function profile store to obtain a list of relevant functions. In addition, the method includes querying, using the list of relevant functions, a function correlation store to obtain a list of related functions and a corresponding code segment reference for each related function in the list of related functions. Also, the method includes selecting, based on a correlation score for each related function from the list of related functions and a threshold, a highest ranked code segment reference to obtain a list of correlated functions. Further, the method includes removing duplicate functions between the list of relevant functions and the list of correlated functions to obtain a list of target functions. The method also includes using at least the list of target functions to generate a plurality of code candidates.

### BRIEF DESCRIPTION OF DRAWINGS

Certain embodiments of the disclosure will be described with reference to the accompanying drawings. However, the accompanying drawings illustrate only certain aspects or implementations of the disclosure by way of example and are not meant to limit the scope of the claims.

FIG. 1 shows a diagram of a system in accordance with one or more embodiments of the invention.

FIG. 2.1 shows a diagram of a contextual code generator in accordance with one or more embodiments of the invention.

FIG. 2.2 shows a diagram of storage in accordance with one or more embodiments of the invention.

FIG. 3 shows a flowchart of a method for obtaining function embeddings in accordance with one or more embodiments of the invention.

FIG. 4.1 shows a flowchart of a method for obtaining a list of target functions in accordance with one or more embodiments of the invention.

FIG. 4.2 shows a flowchart of a method for generating a plurality of code candidates in accordance with one or more embodiments of the invention.

FIG. 5 shows a computing system in accordance with one or more embodiments of the invention.

### DETAILED DESCRIPTION

With the rapid advancement of generative artificial intelligence (AI), code generation tools are now used to assist in programming. This has streamlined the software development processes. However, these tools are typically too generalized because they fail to specifically target particular libraries.

In certain scenarios, a user may want to generate code using functionalities relating to specific hardware components. The hardware-specific libraries contain a wide array of basic functions, and programmers typically prefer to call these basic functions to leverage their features when interacting with the specific hardware components. However, AI code generation tools often lack this background knowledge, thus failing to invoke existing functions from the hardware-specific libraries.

A current approach to generating code is using prompt engineering, which takes all external interfaces from the library as part of the prompt, adds the user's query, and submitsit to the large language model (LLM). However, a significant limitation to this approach is its impracticability when dealing with large-scale libraries. Due to an excessive amount of data that needs to be included in the prompt, the model cannot effectively process all content in the prompt. This results in the generation of inaccurate code. As a non-limiting example, if a library includes 1000 functions, a user will find it impractical to include the 1000 functions in the prompt.

Another existing approach is to utilize retrieval augmented generation (RAG). In this approach, the user's input is translated into an embedding vector, which can then be used to query a vector database to find the most relevant functions. These relevant functions are then used by the LLM to generate code. However, a significant limitation to this approach is that the system is unware of the correlation among functions. In certain scenarios, when using RAG to search code libraries, a function may be retrieved (i.e., relevant function) because its functionality description is one of the closest to the user input requirements. However, having just the relevant function may be insufficient. As a non-limiting example, if the function gci_ctx_read_path is retrieved as the relevant function, generally gcfg_open and gcfg_close are needed before and after this function to operate effectively. However, gcfg_open and gcfg_close were not retrieved by RAG because these two functions did not correlate with the user's input requirements. Consequently, these two functions are not included in prompt for code generation. As a result, the code that is generated may be inaccurate.

The limitations of the traditional approaches to generating code using generative AI restricts the flexibility and usability of current LLMs in real-world code generation applications. For at least the reasons discussed above, a fundamentally different approach is needed to address these challenges and improve the efficiency and accuracy of code generation. Embodiments of the invention relate to a method for generating a multiple code candidates. As a result of the processes discussed below, one or more embodiments disclosed herein advantageously ensure an improvement of contextual understanding of AI-driven code generation systems. This will ensure the inclusion of relevant functions for more comprehensive and effective code generation.

The following describes one or more embodiments.

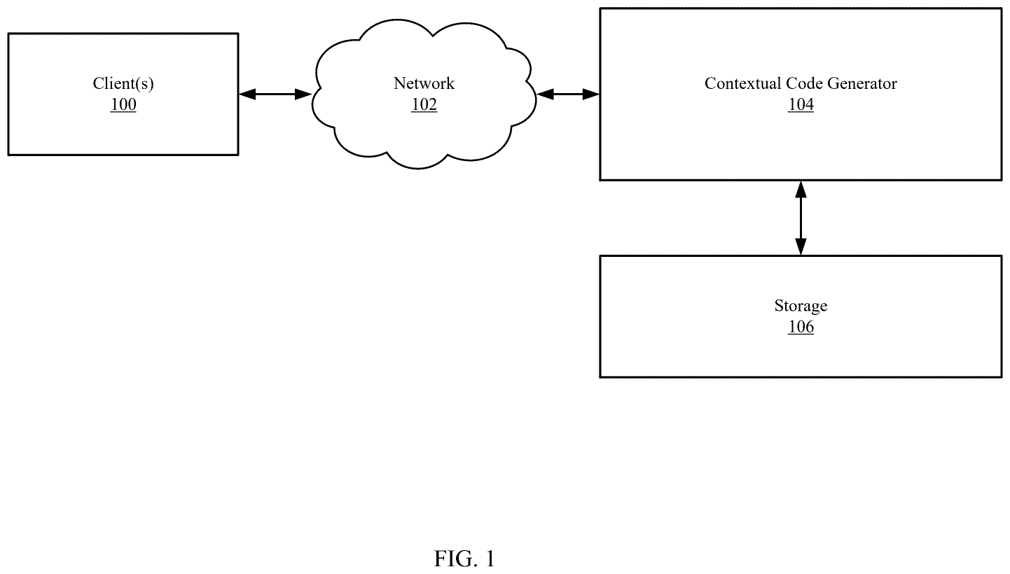

FIG. 1 shows a system in accordance with one or more embodiments of the invention. The system may include any number of clients (100), a network (102), a contextual code generator (104), and storage (106). The system may include additional, fewer, and/or different components without departing from the scope of the invention. Each component may be operably/operatively connected to any of the other components via any combination of wired and/or wireless connections. Each of these system components is described below.

In one or more embodiments, the client(s) (100) and the contextual code generator (104) may be operatively connected to one another through a network (102) (e.g., a local area network (LAN), a wide area network (WAN) such as the Internet, a mobile network, any other network type, or a combination thereof). The network (102) may be implemented using any combination of wired and/or wireless connections. Further, the network (102) may encompass various interconnected, network-enabled subcomponents (or systems) (e.g., switches, routers, gateways, etc.) that may facilitate communications between the client(s) (100) and the contextual code generator (104). Moreover, the client(s) (100) and the contextual code generator (104) may communicate with one another using any combination of wired and/or wireless communication protocols.

In one or more embodiments, the contextual code generator (104) and the storage (106) may be operatively connected to one another. Though not shown in FIG. 1, the aforementioned components may be operatively connected through a network (102) (e.g., a local area network (LAN), a wide area network (WAN) such as the Internet, a mobile network, any other network type, or a combination thereof). In one or more embodiments, the contextual code generator (104) and the storage (106) may be located on a single physical and/or logical computing system.

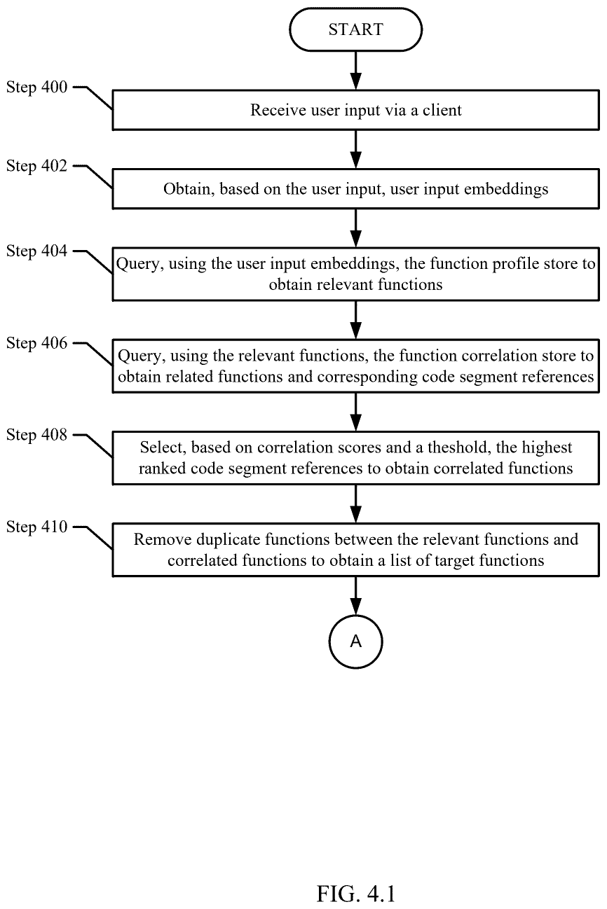

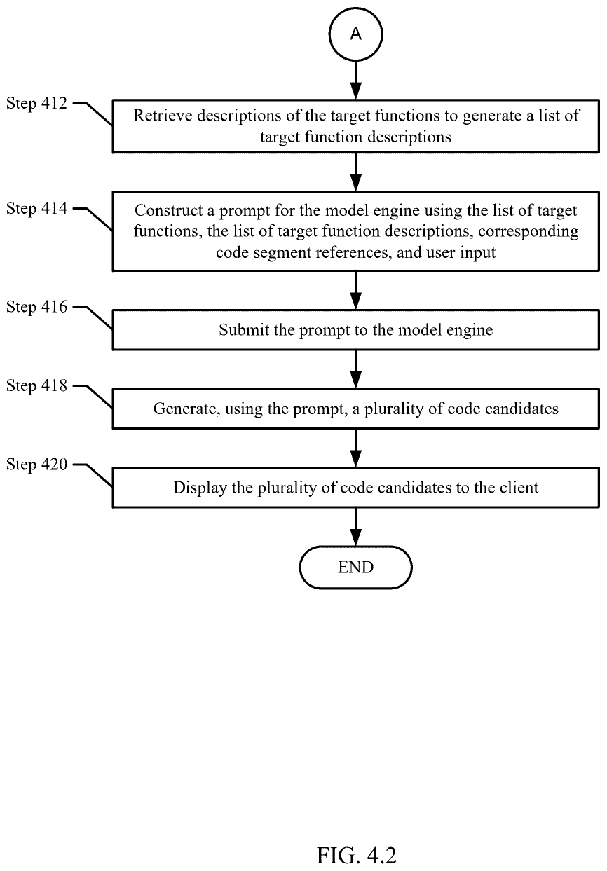

In one or more embodiments, the client(s) (100) includes function to permit users to interact with the contextual code generator (104). Further, the client(s) (100) includes functionality to perform at least a portion of the methods shown in FIGS. 4.1-4.2. One of ordinary skill will appreciate that the client(s) (100) may perform other functionalities without departing from the scope of the invention.

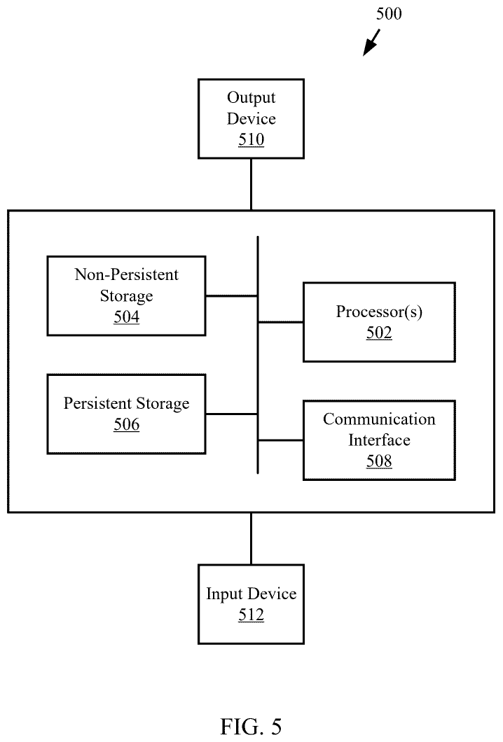

In one or more embodiments disclosed herein, the client(s) (100) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the client(s) (100) may be a computing system (e.g., 500, FIG. 5) as discussed below in more detail in FIG. 5.

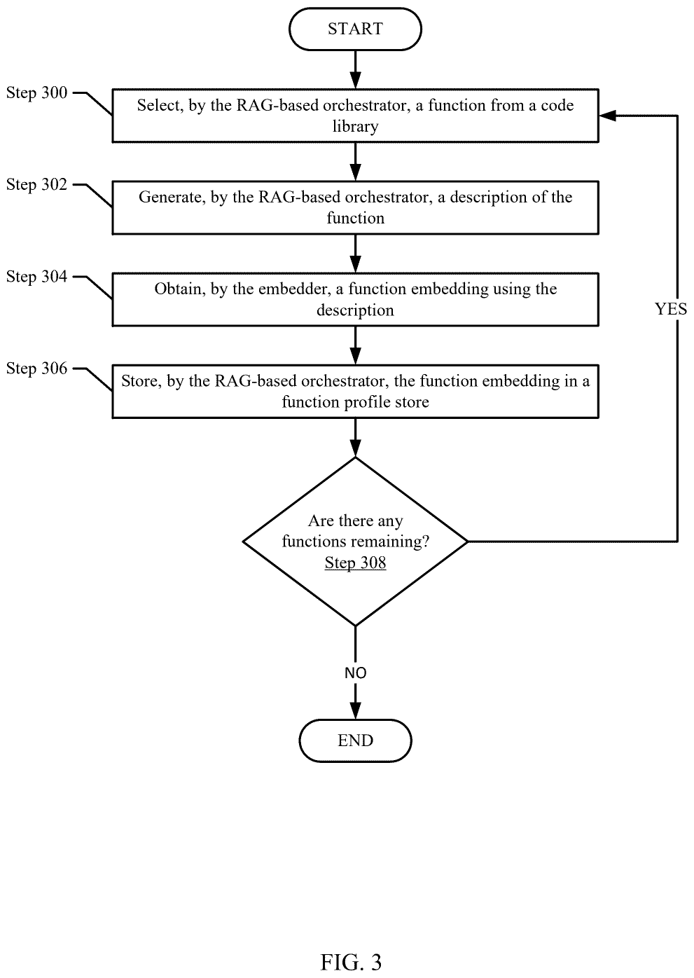

In one or more embodiments, the contextual code generator (104) includes functionality to generate code candidates by utilizing large language model (LLM) capabilities and integrating RAG methodology. In one or more embodiments, the contextual code generator (104) perceives the correlation between functions using contextual information obtained through the use of RAG. As a result, the contextual code generator (104) produces more specific and precise code output by retrieving seemingly unrelated but essential functions to assist in completing a task given by the client(s) (100). Further, the contextual code generator (104) addresses the issue of overly generalized code generation by generating code to be more closely aligned with actual application scenarios. In one or more embodiments, the contextual code generator (104) includes functionality to perform at least a portion of the methods shown in FIGS. 3-4.2. One of ordinary skill will appreciate that the contextual code generator (104) may perform other functionalities without departing from the scope of the invention.

In one or more embodiments disclosed herein, the contextual code generator (104) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the contextual code generator (104) may be implemented on a computing system (e.g., 500, FIG. 5) as discussed below in more detail in FIG. 5.

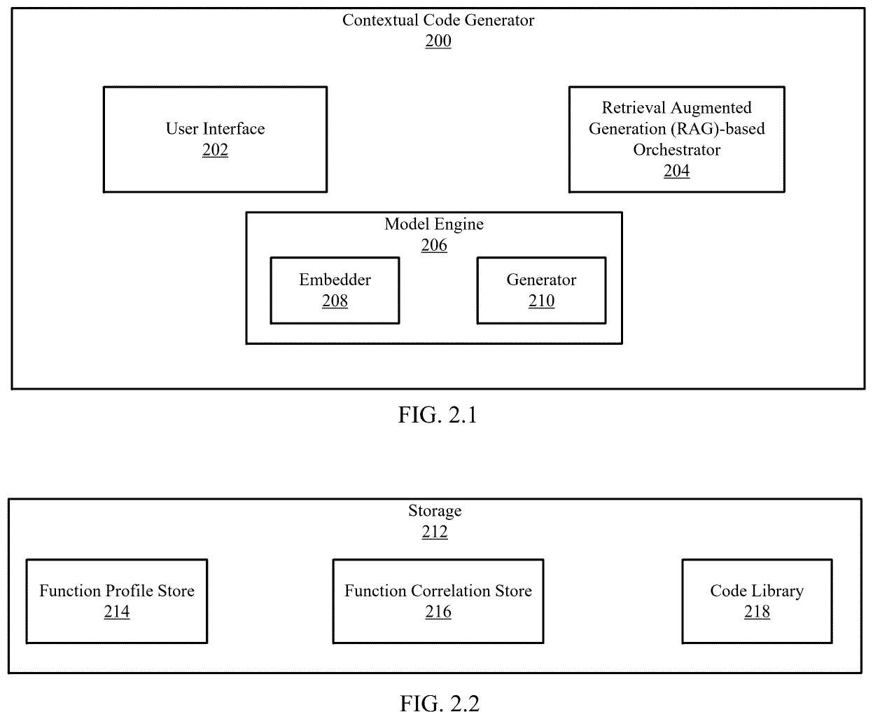

Additional detail regarding one or more embodiments of the contextual code generator is described in FIG. 2.1.

In one or more embodiments, the storage (106) includes functionality to store functions and corresponding function information. The storage (106) also includes functionality to store the correlation information between functions. In one or more embodiments, the storage includes a function profile store (described below), a function correlation store (described below), and a code library (described below). The storage (106) may be volatile storage, non-volatile storage, or any combination thereof. Examples of a storage include (but are not limited to): a hard disk drive (HDD), a solid-state drive (SSD), random access memory (RAM), flash memory, a tap drive, a fibre-channel (FC) based storage device, a floppy disk, a diskette, a compact disc (CD), a digital versatile disc (DVD), a non-volatile memory express (NVMe) device, a NVMe over Fabrics (NVMe-oF) device, resistive RAM (ReRAM), persistent memory (PMEM), virtualized storage, and virtualized memory.

Additional detail regarding one or more embodiments of the storage is described below in FIG. 2.2.

Turning to FIG. 2.1, FIG. 2.1 shows a diagram of a contextual code generator (200) in accordance with one or more embodiments of the invention. The contextual code generator (200) includes a user interface (202), a RAG-based orchestrator (204) and a model engine (206). Each of these components is described below.

In one or more embodiments, the user interface (202) includes functionality to facilitate communications between the contextual code generator (200) and the client(s) (e.g., client(s) (100) in FIG. 1) to determine the requirements to generate code candidates. In one or more embodiments, the user interface (202) receives user queries and user requests. In one or more embodiments, the user interface (202) transmits the user queries and user requests to the RAG-based orchestrator. In one or more embodiments, the user interface (202). In one or more embodiments, the user interface (202) may take various forms, such as a chatbox or similar interface.

In one or more embodiments, the RAG-based orchestrator (204) includes functionality to generate function descriptions and function embeddings for each function in the storage (e.g., storage (106) in FIG. 1). In one or more embodiments, the RAG-based orchestrator (204) also receives user queries from the user interface (202). In one or more embodiments, the RAG-based orchestrator (204) may then convert the user queries into embeddings using the model engine (206). In one or more embodiments, the RAG-based orchestrator (204) also queries the function profile store (described below) and the function correlation store (described below) to retrieve related and correlated functions. These functions are then used in a prompt that is submitted to the model engine (206) for code generation.

In one or more embodiments, the RAG-based orchestrator (204) may be a physical device or a virtual device (i.e., a virtual machine executing on one or more physical devices) such as a personal computing system (e.g., a laptop, a cell phone, a tablet computer, a virtual machine executing on a server, etc.) of a user. For example, the RAG-based orchestrator (204) may be implemented on a computing system (e.g., 500, FIG. 5) as discussed below in more detail in FIG. 5.

One of ordinary skill will appreciate that the RAG-based orchestrator (204) may perform other functionalities without departing from the scope of the invention. Additional detail regarding one or more embodiments of the RAG-based orchestrator (204) are described in FIGS. 3-4.2.

In one or more embodiments, the model engine (206) includes functionality to generate code candidates that meets the prompt requirements based on the prompt submitted by the RAG-based orchestrator (204). The model engine (206) uses generative capabilities to generate responses to the user. One of ordinary skill will appreciate that the model engine (206) may perform other functionalities without departing from the scope of the invention.

In one or more embodiments, the model engine (206) may include an embedder (208) and a generator (210). The embedder serves the RAG-based orchestrator (204) for generating embeddings and the function profile store (described below) for storing function descriptions. The generator (210) serves the RAG-based orchestrator (204) for code generation.

Turning to FIG. 2.2, FIG. 2.2 shows a diagram of storage in accordance with one or more embodiments of the invention. The storage (212) may take various forms, such as a database for storing functions and function information. The storage (212) includes the function profile store (214), the function correlation store (216), and the code library (218). Each of these system components is described below.

In one or more embodiments, the function profile store (214) stores profile information of the functions in the code library (218). The profile information may include, but is not limited to, descriptions of each function and parameter calls for each function in the code library (218) . . . . In one or more embodiments, the function profile store (214) is constructed to utilize the embedder (208, FIG. 2.1) of the model engine (206, FIG. 2.1) to encode function profile information into embeddings and storing them within the function profile store (214). The function profile store (214) may take various forms, such as a vector database. One of ordinary skill will appreciate that the function profile store (214) may perform other functionalities without departing from the scope of the invention.

In one or more embodiments, the function correlation store (216) records correlation information between functions. In other words, the function correlation store (216) records how functions in the code library (218) have been utilized in previous code bases. This assists the RAG-based orchestrator (204, FIG. 2.1) to retrieve seemingly unrelated but essential functions to improve code generation.

In one or more embodiments, the function correlation store (216) employs a sparse matrix data model for storage and utilizes collaborative filtering for construction, which is explained below.

In one or more embodiments, the function correlation store (216) is built by traversing each function's code segment. As a result, when multiple functions are called within the same segment, these functions are considered to be correlated. As a non-limiting example, when using the function gci_ctx_read_path to read configuration, functions such as gcfg_open and gcfg_close frequently appear. Therefore, these three functions would be deemed to be correlated with each other.

In one or more embodiments, the relationships between functions are recorded using a matrix data structure. In this matrix, each cell represents the degree of correlation between two functions. The following is a non-limiting example of a correlation matrix in the function correlation store (216).

| | | other | | other | | | |
|---|---|---|---|---|---|---|---|
| | gci_ctx_{—} | function | gci_ctx_read_{—} | function | gci_ctx_{—} | | |
| | read_path | x | path_inline | y | read_var | gcfg_open | gcfg_close |
| gci_ctx_read_path | N/A | 0.3 | 0 | 0.4 | 0 | 0.9 | 0.9 |
| other function x | N/A | N/A | 0 | 0 | 0 | 0 | 0 |
| gci_ctx_read_{—} | N/A | N/A | N/A | 0 | 0 | 0.9 | 0.9 |
| path_inline | | | | | | | |
| other function y | N/A | N/A | N/A | N/A | 0 | 0 | 0 |
| gci_ctx_read_var | N/A | N/A | N/A | N/A | N/A | 0.9 | 0.9 |
| gcfg_open | N/A | N/A | N/A | N/A | N/A | N/A | 1 |
| gcfg_close | N/A | N/A | N/A | N/A | N/A | N/A | N/A |

As seen in the matrix above, each row and column corresponds to a function, and the elements in the matrix represent the degree of correlation between two functions. Based on the matrix, function gci_ctx_read_path is highly correlated to functions gcfg_open and gcfg_close because the degree of correlation for both relationships is 0.9. Similarly, gci_ctx_read_var is highly correlated to functions gcfg_open and gcfg_close because the degree of correlation for both relationships is 0.9. In the exemplary matrix, functions that have a degree of correlation below 0.4 may be deemed to not be highly correlated.

The degree of correlation is calculated by collaborative filtering. Specifically, the amount of occurrences the pairs of functions appear together in each code segment are recorded, and their correlation is calculated based on their frequency of occurrence. The matrix also records each code reference address that corresponds to the correlation score. As a non-limiting example, there is a set of functions, {f1, f2, f3, . . . , fn} and a set of code segments, {c1, c2, c3, . . . , cm}. For each function pair, (fᵢ, fⱼ), each co-occurrence in all the code segments is counted and recorded.

There are many methods for scoring the correlation between functions. The following describes to methods for scoring the correlation between functions. However, the invention is not limited to these methods; rather, any method for scoring the correlation between functions may be used without departing from the invention.

Referring to the two methods, in the first method, the scoring of the correlation between functions is performed by calculating the co-occurrence count and treating it as the score. In the second method, the co-occurrence count can be normalized by dividing it by the total number of code segments to obtain a relative frequency. This relative frequency may serve as the score for the correlation degree, such as the matrix above. As a non-limiting example, if functions fᵢ and fⱼ co-occur 20 times in a total of 100 code segments, the correlation score would be 20 divided by 100, resulting in 0.2.

In one or more embodiments, the code library (218) stores functions.

Turning to FIG. 3, FIG. 3 shows a flowchart of a method for obtaining function embeddings in accordance with one or more embodiments of the invention. The method may be performed by, for example, the contextual code generator (200, FIG. 2.1).

While the various steps in the flowchart shown in FIG. 3 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

In step 300, the RAG-based orchestrator (e.g., RAG-based orchestrator (204), FIG. 2.1) selects a function from a code library (e.g., code library (218), FIG. 2.2). In one or more embodiments, the RAG-based orchestrator is operatively connected to the code library.

In step 302, the RAG-based orchestrator (e.g., RAG-based orchestrator (204), FIG. 2.1) generates a description of the function. In one or more embodiments, the description may include, but is not limited to, comments of functionality, input parameters and output values of the function.

In step 304, the embedder (e.g., embedder (208), FIG. 2.1) obtains a function embedding using the description. In one or more embodiments, the embedder treats the description as a document and encodes it as a function embedding. In one or more embodiments, embeddings represent text in a numerical representation. In one or more embodiments, an “embedding” is an ordered collection of numeric values that represents an input in a particular embedding space. For example, an embedding may be a vector of floating point or other numeric values that has a fixed dimensionality.

In step 306, the RAG-based orchestrator (e.g., RAG-based orchestrator (204), FIG. 2.1) stores the function embedding in a function profile store.

In step 308, a determination is made as to whether there are any remaining functions left. Accordingly, in one or more embodiments, if the result of this determination is YES, the method proceeds back to step 300. Alternatively, if the result of this determination is NO, the method may end following step 308.

Turning to FIGS. 4.1-4.2, FIGS. 4.1-4.2 shows a method for generating a set of code candidates. More specifically, FIG. 4.1 shows a flowchart of a method for obtaining a list of target functions in accordance with one or more embodiments of the invention and FIG. 4.2 shows a flowchart of a method for generating a plurality of code candidates in accordance with one or more embodiments of the invention. The method shown in FIGS. 4.1-4.2 may be performed by, for example, the contextual code generator (e.g., contextual code generator (200) in FIG. 2.1).

While the various steps in the flowchart shown in FIGS. 4.1-4.2 are presented and described sequentially, one of ordinary skill in the relevant art, having the benefit of this Detailed Description, will appreciate that some or all of the steps may be executed in different orders, that some or all of the steps may be combined or omitted, and/or that some or all of the steps may be executed in parallel.

Turning to FIG. 4.1, in step 400, user input is received via a client. User input may be in the form of text, audio, video, touch, motion or any combination thereof. In one or more embodiments, the user input may be received via the user interface (e.g., user interface (202), FIG. 2.1). As a non-limiting example, a user may want to give the following task: “Write the code that reads a specific configuration from a gconfig component, where the configuration's memory is allocated automatically”.

In step 402, user input embeddings are obtained based on the user input. In one or more embodiments, the embedder (e.g., embedder (208), FIG. 2.1) generates the user input embeddings.

In step 404, the function profile store is queried using the user input embeddings to obtain relevant functions. In one or more embodiments, the RAG-based orchestrator (e.g., RAG-based orchestrator (204), FIG. 2.1) queries the function profile store to obtain the relevant functions. In one or more embodiments, relevant functions represent functions that are closely related to the user input. As a non-limiting example, based on the user input above, the functions gci_ctx_read_path, gci_ctx_read_path_inline, and gci_ctx_read_var are retrieved from the function profile store as relevant functions because their functionality descriptions are closest to the user input.

In step 406, the function correlation store is queried using the relevant functions to obtain related functions and corresponding code segment references. In one or more embodiments, the RAG-based orchestrator (e.g., RAG-based orchestrator (204), FIG. 2.1) queries the function correlation store to obtain the related functions and their corresponding code segment references. In one or more embodiments, related functions represent functions that are related (i.e., has some degree of correlation) to the relevant functions retrieved in step 404.

In step 408, the highest code segment references are selected based on correlation scores and a threshold to obtain correlated functions. In one or more embodiments, the user may select a threshold. As a non-limiting example, the threshold for the correlation score is 0.8. As such, the highest code segment references correspond to functions that have a correlation score that is at least 0.8. Continuing with the above example and with reference to the correlation matrix shown above, gcfg_open and gcfg_close because these functions have a correlation score higher than the threshold (see matrix above). Therefore, these functions represent the correlated functions. In one or more embodiments, correlated functions represent functions that are not directly related to the user input, but are crucial operations for implementing the relevant functions to complete the task given by the user.

In step 410, the duplicate functions (if any) are removed between the relevant functions and correlated functions to obtain a list of target functions. In one or more embodiments, the list of target functions include the relevant functions retried in step 404 and the correlated functions obtained in step 408.

Turning to FIG. 4.2, in step 412, descriptions of the target functions are retrieved from the function profile store to generate a list of target function descriptions. In one or more embodiments, the RAG-based orchestrator (e.g., RAG-based orchestrator (204), FIG. 2.1) generates the list of target function descriptions. In one or more embodiments, the description may include, but is not limited to, comments of functionality, input parameters and output values of the function.

In step 414, a prompt is constructed for the model engine using the list of target functions, the list of target function descriptions, corresponding code segment references, and user input. In one or more embodiments, the RAG-based orchestrator (e.g., RAG-based orchestrator (204), FIG. 2.1) generates the prompt. Continuing with the above example, the RAG-based orchestrator generates a prompt based on the template, as follows:
“Write the code that reads a specific configuration from a gconfig component, where the configuration's memory is allocated automatically. You can use the following functions from the hardware-specific library:
gci_ctx_read_path: {Profile: This function serves . . . }
gci_ctx_read_path_inline: {Profile: This function serves . . . }
gci_ctx_read_var: {Profile: This function serves . . . }
gcfg_open: {Profile: This function serves . . . }
gcfg_close: {Profile: This function serves . . . }
Ensure to include the necessary functions to handle the automatic allocation of memory. You can reference the following code segment:
Code segment 1 from xxx.cpp:600:800: xxxxx.
Code segment 2 from xxx.cpp:200:400: xxxxx.

In step 416, the prompt is submitted to the model engine (e.g., model engine (206), FIG. 2.1). In one or more embodiments, the RAG-based orchestrator (e.g., RAG-based orchestrator (204), FIG. 2.1) submits the prompt to the model engine.

In step 418, a plurality (or set) of code candidates (i.e., source code) is generated using the prompt. In one or more embodiments, the generator (e.g., generator (210), FIG. 2.1) of the model engine (e.g., model engine (206), FIG. 2.1) is utilized to generate the plurality of code candidates. As a non-limiting example, three code candidates are generated (see below).

| | Code Candidate 1 | Code Candidate 2 | Code Candidate 3 |
|---|---|---|---|
| Matching | 0.8 | 0.6 | 0.5 |
| Score | | | |
| Code | . . . | . . . | . . . |
| | gcfg_open( ); | gcfg_open( ); | gcfg_open( ); |
| | . . . | . . . | . . . |
| | gci_ctx_read_{—} | gci_ctx_read_{—} | gci_ctx_read_{—} |
| | path(p); | path_inline(p); | var(p); |
| | . . . | . . . | . . . |
| | gcfg_close( ); | gcfg_close( ); | gcfg_close( ); |

The first code candidate (Code Candidate 1) is prioritized due to the ability of gci_ctx_read_path to provide the requirement of the configuration's memory allocating automatically, meeting the requirements of the user input. As such, it has the highest matching score out of all three code candidates.

In step 420, the plurality of code candidates is displayed to the client. In one or more embodiments, the plurality of code candidates, along with the corresponding matching score, is displayed via the user interface (e.g., user interface (202), FIG. 2.1).

Embodiments of the disclosure may be implemented using computing devices. FIG. 5 shows a diagram of a computing device (500) in accordance with one or more embodiments. The computing device (500) may include one or more computer processors (152), non-persistent storage (504) (e.g., volatile memory, such as random access memory (RAM), cache memory), persistent storage (506) (e.g., a hard disk, an optical drive such as a compact disk (CD) drive or digital versatile disk (DVD) drive, a flash memory, etc.), a communication interface (508) (e.g., Bluetooth interface, infrared interface, network interface, optical interface, etc.), input devices (512), output devices (510), and numerous other elements (not shown) and functionalities. Each of these components is described below.

In one embodiment, the computer processor(s) (502) may be an integrated circuit for processing instructions. For example, the computer processor(s) (502) may be one or more cores or micro-cores of a processor. The computing device (500) may also include one or more input devices (512), such as a touchscreen, keyboard, mouse, microphone, touchpad, electronic pen, or any other type of input device. The communication interface (508) may include an integrated circuit for connecting the computing device (500) to a network (not shown) (e.g., a local area network (LAN), a wide area network (WAN) such as the Internet, mobile network, or any other type of network) and/or to another device, such as another computing device.

In one embodiment, the computing device (500) may include one or more output devices (510), such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) (512, 510) may be locally or remotely connected to the computer processor(s) (502), non-persistent storage (504), and persistent storage (506). Many diverse types of computing devices exist, and the aforementioned input and output device(s) (512, 510) may take other forms.

The problems discussed above should be understood as being examples of problems solved by embodiments of the disclosure and the disclosure should not be limited to solving the same/similar problems. The disclosed disclosure is broadly applicable to address a range of problems beyond those discussed herein.

In the detailed description of the embodiments of the invention, numerous specific details are set forth in order to provide a more thorough understanding of one or more embodiments of the invention. However, it will be apparent to one of ordinary skill in the art that the one or more embodiments of the invention may be practiced without these specific details. In other instances, well-known features have not been described in detail to avoid unnecessarily complicating the description.

In the prior description of the figures, any component described with regard to a figure, in various embodiments of the invention, may be equivalent to one or more like-named components described with regard to any other figure. For brevity, descriptions of these components are not repeated with regard to each figure. Thus, each and every embodiment of the components of each figure is incorporated by reference and assumed to be optionally present within every other figure having one or more like-named components. Additionally, in accordance with various embodiments of the invention, any description of the components of a figure is to be interpreted as an optional embodiment, which may be implemented in addition to, in conjunction with, or in place of the embodiments described with regard to a corresponding like-named component in any other figure.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this Detailed Description, will appreciate that other embodiments can be devised which do not depart from the scope of embodiments as disclosed herein. Accordingly, the scope of embodiments described herein should be limited only by the attached claims.

What is claimed is:

1. A method for generating code candidates, the method comprising:
receiving, from a client, user input generated by a user of the client;
obtaining, based on the user input, user input embeddings;
querying, using the user input embeddings, a function profile store to obtain a list of relevant functions;
querying, using the list of relevant functions, a function correlation store to obtain a list of related functions and a corresponding code segment reference for each related function in the list of related functions;
selecting, based on a correlation score of each related function from the list of related functions and a threshold, a highest ranked code segment reference to obtain a list of correlated functions;
removing duplicate functions between the list of relevant functions and the list of correlated functions to obtain a list of target functions; and
using at least the list of target functions to generate a plurality of code candidates.

2. The method of claim 1, wherein the function profile store is a vector database comprising function embeddings of each function in a code library.

3. The method of claim 1, wherein the function correlation store is a sparse matrix data model comprising correlation scores between each function in a code library.

4. The method of claim 1, wherein using at least the list of target functions to generate the plurality of code candidates, comprises:
retrieving a description of each target function in the list of target functions to generate a list of target function descriptions;
constructing a prompt for a model engine, wherein the prompt comprises the list of target functions, the list of target function descriptions, the corresponding code segment references, and the user input;
submitting the prompt to the model engine;
generating, by the model engine and using the prompt, the plurality of code candidates, wherein the plurality of code candidates comprise source code; and
providing the plurality of code candidates to the user.

5. The method of claim 4, wherein the model engine implements a large language model (LLM) to generate the plurality of code candidates.

6. The method of claim 1, the method further comprising:
prior to the querying, using the user input embeddings, the function profile store to obtain the list of relevant functions:
selecting, by an orchestrator, a first function from a code library;
generating, by the orchestrator, a first description of the first function;
obtaining, by an embedder, a first function embedding using the first description; and
storing, by the orchestrator, the first function embedding in the function profile store.

7. The method of claim 6, wherein the orchestrator is based on retrieval augmented generation (RAG).

8. The method of claim 1, wherein the plurality of code candidates meets a set of requirements based on the user input.

9. A non-transitory computer readable medium (CRM) comprising computer readable program code, which when executed by a computer processor, enables the computer to perform a method for generating code candidates, the method comprising:
receiving user input generated by a user;
obtaining, based on the user input, user input embeddings;
querying, using the user input embeddings, a function profile store to obtain a list of relevant functions;
querying, using the list of relevant functions, a function correlation store to obtain a list of related functions and a corresponding code segment reference for each related function in the list of related functions;
selecting, based on a correlation score for each related function from the list of related functions and a threshold, a highest ranked code segment reference to obtain a list of correlated functions;
removing duplicate functions between the list of relevant functions and the list of correlated functions to obtain a list of target functions; and
using at least the list of target functions to generate a plurality of code candidates.

10. The non-transitory CRM of claim 9, wherein the function profile store is a vector database comprising function embeddings of each function in a code library.

11. The non-transitory CRM of claim 9, wherein the function correlation store is a sparse matrix data model comprising correlation scores between each function and corresponding code segment references for each function in a code library.

12. The non-transitory CRM of claim 9, wherein using at least the list of target functions to generate the plurality of code candidates, comprises:
retrieving a description of each target function in the list of target functions to generate a list of target function descriptions;
constructing a prompt for a model engine, wherein the prompt comprises the list of target functions, the list of target function descriptions, the corresponding code segment references, and the user input;
submitting the prompt to the model engine;
generating, by the model engine and using the prompt, the plurality of code candidates; and
providing the plurality of code candidates to the user.

13. The non-transitory CRM of claim 9, the method further comprising:
prior to the querying, using the user input embeddings, the function profile store to obtain the list of relevant functions:
selecting, by an orchestrator, a first function from a code library;
generating, by the orchestrator, a first description of the first function;
obtaining, by an embedder, a first function embedding using the first description; and
storing, by the orchestrator, the first function embedding in the function profile store.

14. The non-transitory CRM of claim 13, wherein the orchestrator is based on retrieval augmented generation (RAG).

15. The non-transitory CRM of claim 9, wherein the plurality of code candidates comprise source code.

16. The non-transitory CRM of claim 9, wherein the plurality of code candidates meets a set of requirements based on the user input.

17. A contextual code generator, comprising:
a processor; and
memory comprising instructions, which when executed by the processor, performs a method for generating code candidates, the method comprising:
receiving, from a client, user input generated by a user of the client;
obtaining, based on the user input, user input embeddings;
querying, using the user input embeddings, a function profile store to obtain a list of relevant functions;
querying, using the list of relevant functions, a function correlation store to obtain a list of related functions and a corresponding code segment reference for each related function in the list of related functions;
selecting, based on a correlation score for each related function from the list of related functions and a threshold, a highest ranked code segment reference to obtain a list of correlated functions;
removing duplicate functions between the list of relevant functions and the list of correlated functions to obtain a list of target functions; and
using at least the list of target functions to generate a plurality of code candidates.

18. The contextual code generator of claim 17, wherein using at least the list of target functions to generate a plurality of code candidates, the method further comprises:
retrieving a description of each target function in the list of target functions to generate a list of target function descriptions;
constructing a prompt for a large language model (LLM) engine, wherein the prompt comprises the list of target functions, the list of target function descriptions, the corresponding code segment references, and the user input;
submitting the prompt to the LLM engine;
generating, by the LLM engine and using the prompt, a plurality of code candidates; and
displaying the plurality of code candidates to the user.

19. The contextual code generator of claim 17, wherein the method further comprises:
prior to the querying, using the user input embeddings, a function profile store to obtain a list of relevant functions:
selecting, by an orchestrator, a first function from a code library;
generating, by the orchestrator, a first description of the first function;
obtaining, by an embedder, a first function embedding using the first description; and
storing, by the orchestrator, the first function embedding in the function profile store.

20. The contextual code generator of claim 19, wherein the orchestrator is based on retrieval augmented generation (RAG) and wherein the plurality of code candidates comprise source code.
